(19) United States
(12) Patent Application Publication
(10) Pub. No.: US 2005/0193113 A1
(43) Pub. Date: Sep. 1, 2005

(54) Server allocation control method

(75) Inventors: Yasuhiro Kokusho, Kawasaki (JP); Satoshi Tutiya, Kawasaki (JP); Tsutomu Kawai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/099,538

(22) Filed: Apr. 6, 2005

Related U.S. Application Data
(63) Continuation of application No. PCT/JP03/04679, filed on Apr. 14, 2003.

(51) Int. Cl. G06F 15/173; G06F 9/46

(52) U.S. Cl. 709/225; 718/102

(57) ABSTRACT

A method to automatically allocate servers to network services in a data center in real time and without need for operators for a load sharing device is provided. In the method, fluctuations in quantity of requests arriving at the network services can be monitored, the value of the quantity of requests for a subsequent fixed time interval can be predicted and, in accordance with the magnitude of the predicted value of the quantity of requests, the quantity of servers allocated to the network services can be controlled. Here, where traffic of the quantity indicated by the predicted value of the quantity of requests arrives at the network services, the number of servers allocated to the network services can be set in such a way that the average response time to the user terminals is equivalent to a response time threshold value or less set in advance by the operations manager.

### TECHNICAL FIELD

The present invention relates to a method for dynamically altering the configuration of server groups allocated to network services to ensure that a fixed standard response time is achieved by a plurality of servers providing said network services.

### BACKGROUND ART

A diversity of network services is currently provided by way of networks such as the Internet. Some of the so-called service providers (xSP), which are companies that provide network services including Internet Service Providers (ISP) and Application Service Providers (ASP) and so on, do not perform the in-house support and management of the servers that provided the network services and instead engage a data center to perform these tasks.

The data center has, in an in-house data center, a plurality of servers of which parts thereof are allocated for each network service. That is to say, server groups composed of a plurality of servers exist for each network service, and service requests to a network service are processed by any server belonging to a corresponding server group. In addition, the data center guarantees the reliability, availability and serviceability on the agreement with each xSP, and also guarantees that the service levels including response time to the service user is a fixed standard or better.

When there are too many servers allocated to a network service the operation rate of the servers is poor and the effective application of the servers is unachievable. Conversely, when there are too few servers, service levels of a fixed standard or better cannot be guaranteed. In addition, because of the real-time fluctuations in load on the servers in accordance with the number of service requests from the plurality of user terminals connected to the network, as long as a data center provides more than one network service there will always be differences in the magnitude of the load among network services. Thereupon, to the extent that the guaranteed service level is maintained, the data center alters the server group configuration by re-arranging the servers allocated to a network service where the load is light or servers not in use to another network services where the load is heavy whereby, accordingly, the effective application of its servers is ensured.

These alterations in the configuration are facilitated by the installation of a load sharing device in a pre-stage to the plurality of servers provided at the data center whereupon, by the alteration of the settings of the load sharing device, a specific server is added to a server group providing a certain network service or, conversely, a specific server is removed from a server group providing a certain network service. In addition, by distributing the service requests from the user terminals in accordance with a distribution rate set in advance, the load sharing device is able to disperse the load on servers affiliated to a server group.

The settings of the load sharing device are altered manually in accordance with the experience and judgment of an operations manager of the data center. Also, a device for determining whether the service level is a fixed standard or better in accordance with the existing operating conditions (from CPU operation rate) and automatically altering the settings of the load sharing device has also been proposed (see Japanese Laid-Open Patent Application No. 2002-24192).

However, using the methods of the prior art in which, because the load on the network services fluctuates frequently depending on, for example, time slot, seasonal factors and artificial factors, and these fluctuations are different for each network service, the settings of the load sharing device are set manually, it is difficult for these fluctuation patterns to be predicted based solely on the experience and judgment of an operations manager. In addition, although the methods of the prior art facilitate the automatic setting of the load sharing device in real time without need for an operator, they do not provide a means for adjudging whether or not more servers will be required in the future or whether a lesser number is sufficient. They only allocate servers in accordance with the existing operating conditions and the set service levels. Accordingly, an inherent problem therewith is that the number of servers allocated in accordance with the existing operating conditions will not necessarily form the optimum number of servers for operating conditions that will exist in the future.

### DISCLOSURE OF THE INVENTION

An object of the present invention is the provision of a method and program by which the configuration of a plurality of servers allocated to network services can be dynamically controlled in response to the number of requests from user terminals. A further object is the provision of a method and program for predicting the number of arriving requests for a subsequent fixed time interval based on fluctuations in the number of arriving requests at the network services, and controlling the allocation of servers to the network services in accordance with the predicted value.

The abovementioned objects are achieved according to a first aspect of the present invention, by providing a method for adjusting the number of servers belonging to a server group in a network system which includes a plurality of user terminals connected to a network and server groups each containing a plurality of servers connected to the network to process requests from the plurality of user terminals. The method includes: storing the number of requests from the plurality of user terminals for prescribed time intervals; finding a function to describe a characteristic between time and the number of requests on the basis of a previous stored number of requests; predicting the number of future requests by substituting a future time for the function; obtaining a first average response time per server of the plurality of servers by substituting the predicted number of requests in a relational expression of the number of requests and an average response time per server of the plurality of servers where it is hypothesized that the number of requests from the plurality of user terminals follows a prescribed probability distribution; determining whether the first average response time is a positive value and within a range no more than a threshold value set in advance, and increasing or decreasing the number of servers contained in the server group in accordance with the result of the determination.

According to a more preferred embodiment in the first aspect of the invention, the method further includes selecting one of the servers of the server group if the result for the first average response time in the determination is within the range; hypothesizing that the selected server has been removed from a server group; finding a second average response time per server of the plurality of servers of the hypothesized server group; performing a new determination whether or not the second average response time is within the range; and removing the selected server from the configuration of the server group if the result for the second average response time of the new determination is within the range.

According to a more preferred embodiment in the first aspect of the invention, the selecting, the hypothesizing, the finding a second average response time, the performing a new determination and the removing are repeated and the server belonging to the server group is removed one-by-one until the result for the second average response time in the new determination is outside the range.

According to a more preferred embodiment in the first aspect of the invention, the network system includes an unused server group having a plurality of unused servers connected to the network. And the method further includes selecting one of the servers of the unused server group if the result for the first average response time in the determination is not within the range; and adding the selected server to the server group.

According to a more preferred embodiment in the first aspect of the invention, the method further includes: finding a third average response time per server of the plurality of servers included in a new server group following the addition of the selected server; performing a new determination whether the third average response time is within the range; and selecting one of the servers of the unused server group if the result for the third average response time of the new determination is not within the range. And the finding a third average response time, the performing a new determination and the selecting are repeated and the server belonging to the unused server groups is added one-by-one to the server group until the result for the third average response time of the new determination is within the range.

Further, as a second aspect, the abovementioned object is achieved by providing a program for a resource allocation controller connected to a network in a network system which includes a plurality of user terminals connected to the network, server groups each containing a plurality of servers connected to the network to process requests from the user terminals and a load sharing device connected to the network involving a storage storing the number of requests from the user terminal for prescribed time intervals, a distribution rate of the number of requests and a configuration information of the server groups. The program causes the resource allocation controller to execute the method including: finding a function to describe a characteristic between time and the number of requests on the basis of a previous stored number of requests stored in the load sharing device; predicting the number of future requests by substituting a future time for the function; obtaining a first average response time per server of the plurality of servers by substituting the predicted number of requests in a relational expression of the number of requests and an average response time per server of the plurality of servers where it is hypothesized that the number of requests from the plurality of user terminals follows a prescribed probability distribution; determining whether the first average response time is a positive value and within a range no more than a threshold value set in advance, and increasing or decreasing the number of servers contained in the server group in accordance with the result of the determination.

According to a more preferred embodiment in the second aspect of the invention, the program further causes the resource allocation controller to execute the method including: selecting one of the servers of the server group if the result for the first average response time in the determination is within the range; hypothesizing that the selected server has been removed from a server group; finding a second average response time per server of the plurality of servers of the hypothesized server group; performing a new determination whether or not the second average response time is within the range; and removing the selected server from the configuration of the server group if the result for the second average response time of the new determination is within the range.

According to a more preferred embodiment in the second aspect of the invention, in the program, the selecting, the hypothesizing, the finding a second average response time, the performing a new determination and the removing are repeated. And the server belonging to the server group is removed one-by-one until the result for the second average response time in the new determination is outside the range.

According to a more preferred embodiment in the second aspect of the invention, the network system includes an unused server group having a plurality of unused servers connected to the network. The program further causes the resource allocation controller to execute the method including: selecting one of the servers of the unused server group if the result for the first average response time in the determination is not within the range; and adding the selected server to the server group.

According to a more preferred embodiment in the second aspect of the invention, the program further causes the resource allocation controller to execute the method including: finding a third average response time per server of the plurality of servers included in a new server group following the addition of the selected server; performing a new determination whether the third average response time is within the range; and selecting one of the servers of the unused server group if the result for the third average response time of the new determination is not within the range. And the finding a third average response time, the performing a new determination and the selecting are repeated and the server belonging to the unused server groups is added one-by-one to the server group until the result for the third average response time of the new determination is within the range.

### BRIEF DESCRIPTION OF THE DRAWINGS

FIG. 1 is a diagram for explaining an example of the configuration of an entire system of one embodiment of the present invention;

FIG. 2 is a block diagram illustrating an example configuration of a load sharing device;

FIG. 3 is a block diagram illustrating an example configuration of a mobile terminal such as a mobile telephone or PDA used as user terminals;

FIG. 4 is a block diagram illustrating an example configuration of a server;

FIG. 5 is a diagram illustrating an example data configuration of server group configuration data stored in a RAM of a load sharing device;

FIG. 6 is a diagram illustrating the configuration of statistical information stored in a RAM of a load sharing device;

FIG. 7 is a diagram illustrating an example data configuration of data center configuration information stored in a RAM of a resource allocation controller;

FIG. 8 is a diagram illustrating an example data configuration of a table stored in a RAM of a resource allocation controller in the table which the number of requests processed per second by a server having a CPU of standard clock frequency is stored for each application;

FIG. 9 is a flow chart for explaining a new server group production process;

FIG. 10 and FIG. 11 are flow charts for explaining the process server allocation adjustment processing; and

FIG. 12 is a diagram for explaining a method of prediction utilizing the method of least squares.

### BEST MODE FOR CARRYING OUT THE INVENTION

A description of an embodiment of the present invention is given below with reference to the diagrams. However, the technical range of the present invention is in no way restricted to this embodiment.

The sequence of the explanation of the embodiment of the present invention will be of an example configuration of an entire system in the embodiment, an example configuration of the devices of the abovementioned system, example data configuration stored in the devices of the abovementioned system, and the operational flow for explaining a method of the present invention. First, an explanation will be given of an example configuration of the entire system in the embodiment.

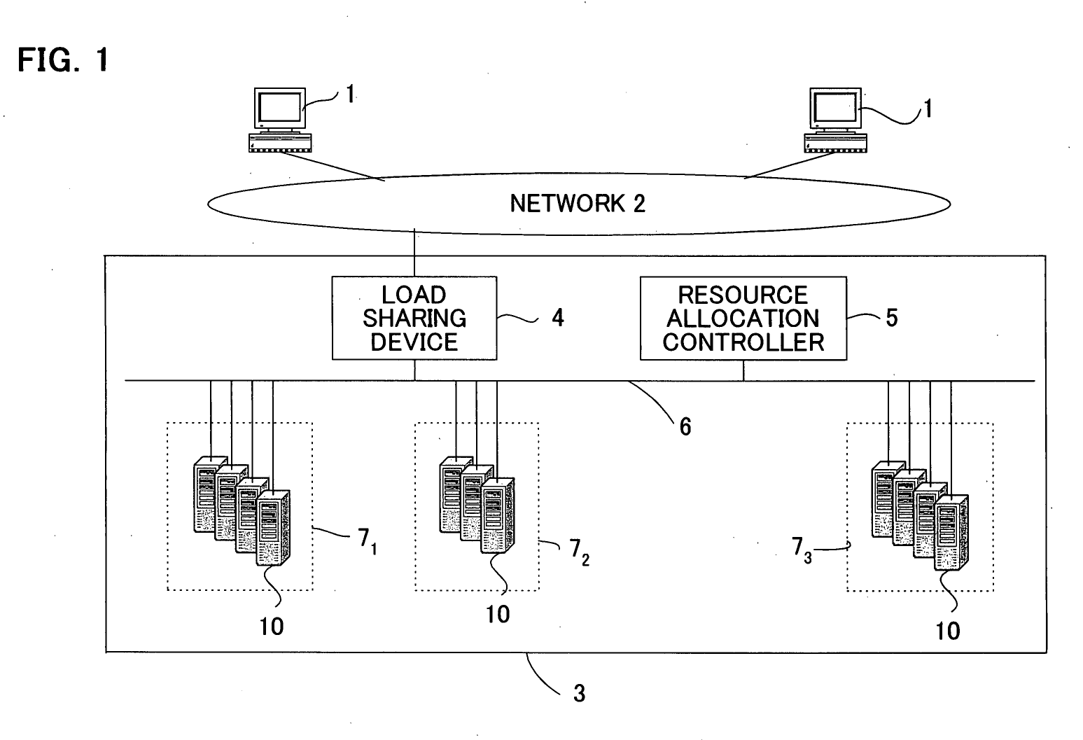

FIG. 1 is a diagram for explaining an example configuration of the entire system of one embodiment of the present invention. For the purpose of simplification of the description, all servers providing the network services of the embodiment of the present invention have been assumed to be servers operated by a web server. A user terminal sends, as a service request, an http request including an address of a home page that user wants to see, and the web server returns to the user terminal contents that correspond to this home page address.

First, a network 2 that connects a plurality of user terminals 1 with a plurality of servers 10 in a data center 3 is established. The network 2 may be a wire or wireless network. The network 2 may be configured as a LAN (Local Area Network) or a WAN (Wide Area Network), or the network 2 may be configured as an Internet.

Examples of a user terminal 1 include a PC (personal computer) or mobile telephone such as a mobile terminal or PDA (Personal Digital Assistant). The plurality of servers 10 within the data center 3 is grouped for each provided network service.

By way of example, in FIG. 1, server groups 71 to 73 for providing a network service are created, and the server groups 71, 72, serving as web servers, provide individual network services. The server group 73 is an unused server group that has not been allocated for any network service. Each of the plurality of servers 10 in the data center is connected to a center LAN 6. The center LAN 6 may be a wire or wireless network.

The network service is provided by processing of a request sent from the user terminal 1 by a server 10 affiliated to a server group, and the sending to the user terminal of a response thereto. By way of example, if the server group 71 is a group for providing home page contents of a company A, any one of the servers 10 of the server group 71 can send contents corresponding to a service request to the user terminal from which the home page address of the company A has been sent as the service request (http request) from the user terminal.

In addition, a load sharing device 4 is provided in a pre-stage to the servers within the data center, and the load sharing device 4 is connected to the center LAN 6 and the network 2. The load sharing device 4 determines which server groups correspond to the request from the user terminal and distributes the requests from the user terminal in accordance with a later-described distribution rate so that the load on servers affiliated to the server group is not concentrated on a specific server.

Furthermore, the load sharing device 4 calculates the number of requests (http requests) sent via the network 2 to each server group 7 across prescribed time intervals and stores this as statistical information. In addition, a resource allocation controller 5 that controls the configuration of the server group 7 by adding and removing servers 10 affiliated to the server group 7 is connected to the center LAN 6.

It should be noted that, although not shown in FIG. 1, a configuration may be adopted that includes a gateway, router, firewall and so on between the load sharing device 4 and the network 2. In addition, although not shown in the diagram, where a hard disk provided in the server interior is insufficient, a storage device such as a disk array or the like may be connected to the exterior of the server 10.

Next, a description will be given of an example configuration of the devices of the system of FIG. 1.

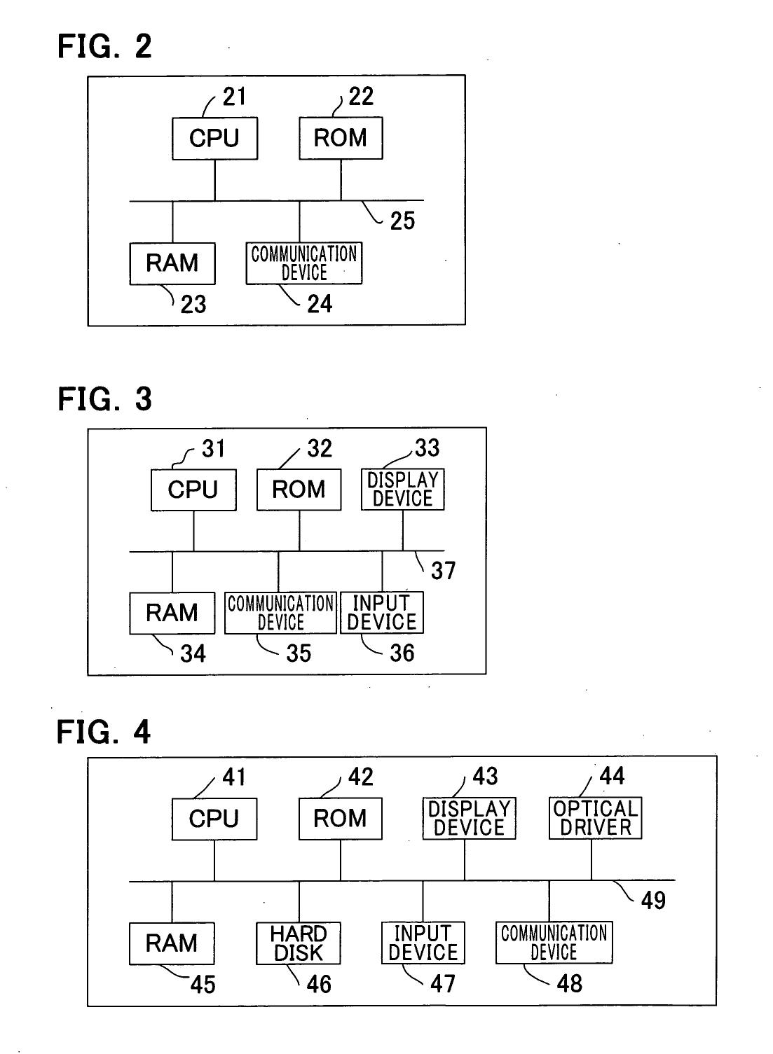

FIG. 2 is a block diagram illustrating an example configuration of the load sharing device 4. A CPU 21 executes the control of the load sharing device 4. A program that is executed when the load sharing device 4 is started, a data necessary for this start and a control program that is transferred to an RAM 23 at the start time are recorded in a ROM (Read Only Memory) 22.

A control program or data including the computational result of the execution of the control program are stored in the RAM (Random Access Memory) 23. A communication device 24, having an interface for connecting the network 2 and the center LAN 6, facilitates the transmission of data to devices connected through the network 2 or the center LAN 6. This connection is afforded by a connection line 25 as shown in FIG. 2.

FIG. 3 is a block diagram illustrating an example configuration of a mobile terminal such as a mobile telephone or PDA that are used as the user terminal 1. A CPU 31 executes the control of the mobile terminals. A program that is executed when the mobile terminal is started, a data necessary for this start and a control program that is transferred to an RAM 34 at the start time are recorded in a ROM 32.

A control program or data including the computational result of the execution of the control program are stored in the RAM 34. A communication device 35, having an interface for connecting the network 2 and the center LAN 6, facilitates the transmission of data to devices connected through the network 2 or the center LAN 6.

An input device 36, which forms a keypad or pen-type input device or the like, is used by the user to input various commands and data. A display device 33, which forms a liquid crystal screen or the like, displays to the user the results of the control executed by the CPU 31. The connection thereof is afforded by a connection line 37 shown in FIG. 3.

FIG. 4 is a block diagram showing an example configuration of the resource allocation controller 5. A CPU 41 executes the control of the resource allocation controller 5. A program executed when the resource allocation controller 5 is started or data necessary for this start are stored in a ROM 42. An OS (Operating System) or data for controlling the resource allocation controller 5 are stored in a hard disk 46.

Data such as the computational result of the execution of the OS are stored in a RAM 45. A communication device 48, having an interface for connecting the network 2 and the center LAN 6, facilitates the transmission of data to devices connected through the network 2 or the center LAN 6.

An input device 47, which forms a keyboard, a mouse or the like, is used by the user to input various commands and data. A display device 43, which forms a liquid crystal monitor or CRT or the like, displays to the user the results of the control executed by the CPU. An optical drive unit 44 is used for the data writing or reading of CD, DVD or MO or such-like media.

Incidentally, by virtue of the fact that a manager can do a remote operation by logging in to the resource allocation controller 5 from the server 10 for which there is connection by way of the network, the resource allocation controller need not have the input device 47 and display device 43. It should be noted that the configuration of the server 10 or the PC used as the user terminal 1 are the same as that of FIG. 4.

Next a description will be given of an example data configuration stored in the devices of the system.

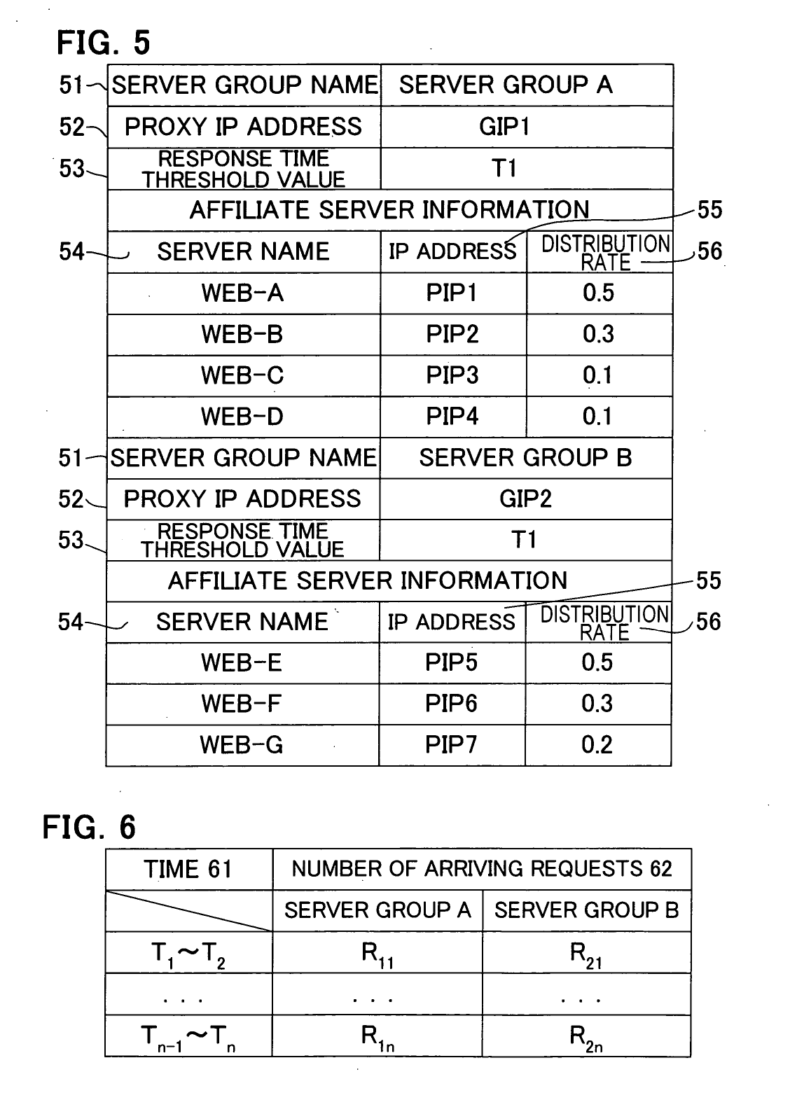

FIG. 5 is a diagram illustrating an example data configuration of server group configuration data stored in the RAM 23 of the load sharing device 4. The server group configuration data stored in each server group includes a server group name 51, representative IP address 52, response time threshold value 53, server name 54 that serves as the affiliate server information, IP address 55 and distribution rate 56.

The server group name 51 is the control name that specifies the server group 7. The representative IP address 52, which is 32-bit number in the case of an IPv4 and a 128-bit number in the case of an IPv6, is a publicly disclosed IP address for the network service that is provided by the server group 7. That is to say, in the utilization of a network service provided by the server group 7₁, the user terminal 1 sends a request (http request) to the representative IP address 52 of the server group 7₁ and, in the utilization of a network service provided by the server group 7₂, the user terminal 1 sends a request to the representative IP address 52 of the server group 7₂.

Although a global IP address is used for the representative IP address 52, a private IP address can be used provided if the network service is provided to a closed organization. The response time threshold value 53 is one of the service levels demanded by the xSP in its agreement with the data center. The data center performs management of the data center 3 based on the allocation of a server 10 to the server group 7 that provides the network service in such a way as to prevent the response time to the user terminal 1 dropping below the response time threshold value 53.

A server name 54 of the affiliate server information is a management name that specifies the server 10 affiliated to the server group 7. The IP address 55 of the affiliate server information includes the IP address of a server that corresponds to the server 54. Although a private IP address is used as the IP address 55, provided there are enough global IP addresses available, a global IP address may also be used.

The distribution rate 56 of the affiliate server information is the rate at which the affiliated server 10 processes the requests from the user terminal 1 accessing to the representative IP address 52 of the server group 7. The load sharing device 4, utilizing the server group configuration information, specifies the server group 7 by searching for the representative IP address that matches the destination IP address of the request (http request) sent from the user terminal 1 and, by selecting the server for processing the requests on the basis of the distribution rate 56 of the affiliate server information of the server group 7 and converting the destination IP address of the request to the selected server IP address 55, transfers the request to the selected server in accordance with the distribution rate.

By way of example, in FIG. 5, the information pertaining to two server groups is stored. In the server group A, the representative IP address 52 is GIP1, the response time threshold value 53 is T1, the server names 54 of the four affiliate servers are WEB-A, WEB-B, WEB-C and WEB-D, the IP addresses 55 thereof are PIP1, PIP2, PIP3 and PIP4, and the distribution rates 56 thereof are 0.5, 0.3, 0.1 and 0.1 respectively. That is to say, of ten requests, five are processed by WEB-A, three are processed by WEB-B, one is processed by WEB-C and one is processed by WEB-D. Similarly in FIG. 5, information pertaining to the representative IP address 52 of the server group B and the affiliate three servers is stored.

FIG. 6 is a diagram illustrating an example data configuration of statistical information stored in the RAM 23 of the load sharing device 4. Values obtained as a total of the number of arriving requests at fixed time intervals are stored as statistical information in each server group. By way of example, in FIG. 6, the number of arriving requests per second is stored and, for a time 61 T₁ to T₂, an R₁₁ number of requests are stored in server A and an R₂₁ number of requests are stored in server B. The newest added data is at the bottom of FIG. 6. In this way information pertaining to the number of arriving requests 62 in an n second interval (n is a natural number) immediately preceding the current time is stored.

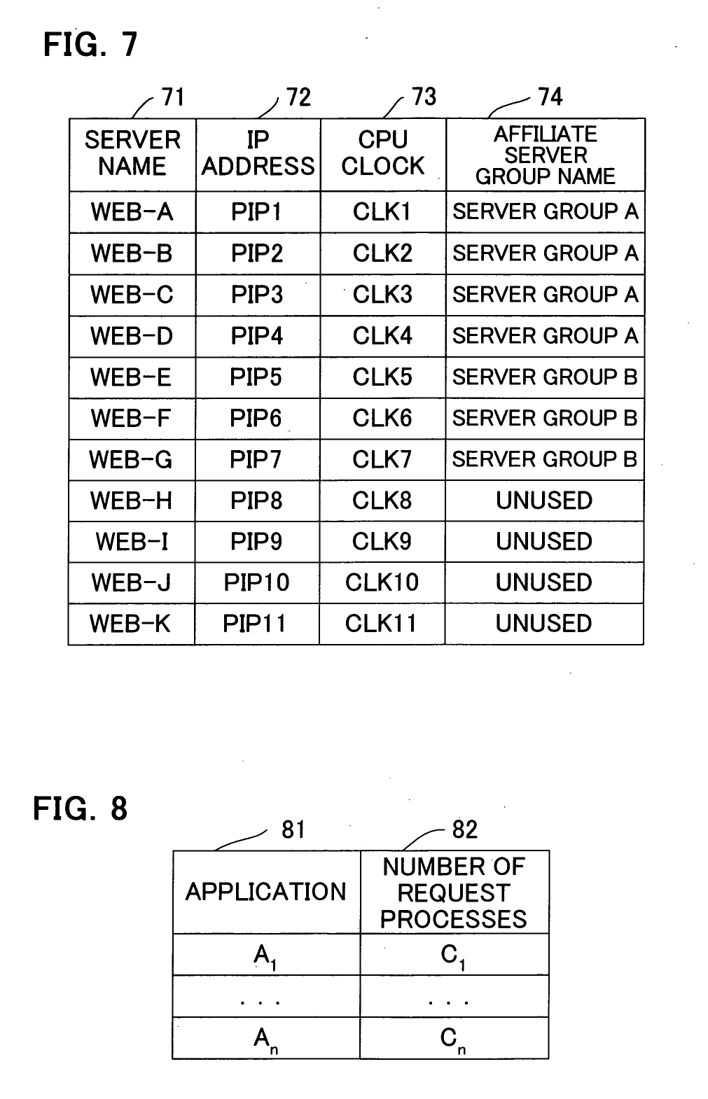

FIG. 7 is a diagram illustrating an example data configuration of the data center configuration information stored in the RAM 45 of the resource allocation controller 5. The information stored in the data center configuration information includes a server name 71 containing unused severs not allocated for a network service, IP address 72, CPU clock speed 73 and affiliate server group name 74. The server name 71 and IP address 72 are equivalent to the server name 54 and IP address 55 of FIG. 5.

The CPU clock speed 73 is stored as a value obtained by dividing the clock frequency of the CPU 41 implemented in the server 10 by a standard clock frequency. In the embodiment of the present invention the standard clock frequency is taken as 1 GHz. It is apparent from the CPU clock speed 73 that the clock frequency implemented in the server 10 is several times larger than the standard clock frequency. For a server 10 in which a plurality of CPU 41 are loaded the stored values are obtained by dividing the sum value of the clock frequencies by the standard clock frequency.

If the average number of processing requests of a server which has the CPU of standard clock frequency (1 GHz) is taken as p, the average number of processing requests of a server is calculated as a value obtained by multiplying the value of the CPU clock speed 73 by μ. The affiliate server group name 74 specifies the server group 7 to which the server 10 of the server names 71 is affiliated.

Different to the server group configuration information of FIG. 5, information of unused servers is also stored in the data center configuration information. By way of example, it is clear in FIG. 7 that the four servers of server names 71 WEB-H, WEB-I, WEB-J and WEB-K are unused servers.

FIG. 8 is a diagram illustrating an example data configuration of a table stored in the RAM 45 of the resource allocation controller 5 in which the number of requests processed per second by a server which has the CPU 41 of standard clock frequency (1 GHz) is stored for each Web server software 81. By way of example, in FIG. 8, it can be seen that when an application A₁ is used as the web server software, a C₁ number of requests are processed per second as a result of the sending of a plurality of http requests to the server in which the CPU 41 of standard clock frequency (1 GHz) is loaded, and that when an application Aₙ is used, a Cₙ number of requests are processed per second as a result of the sending of a plurality of http requests to the server in which the CPU 41 of standard clock frequency (1 GHz). This data is collected in advance and input in advance into the resource allocation controller.

Next, a description will be given of the operational flow for explaining the method of the present invention.

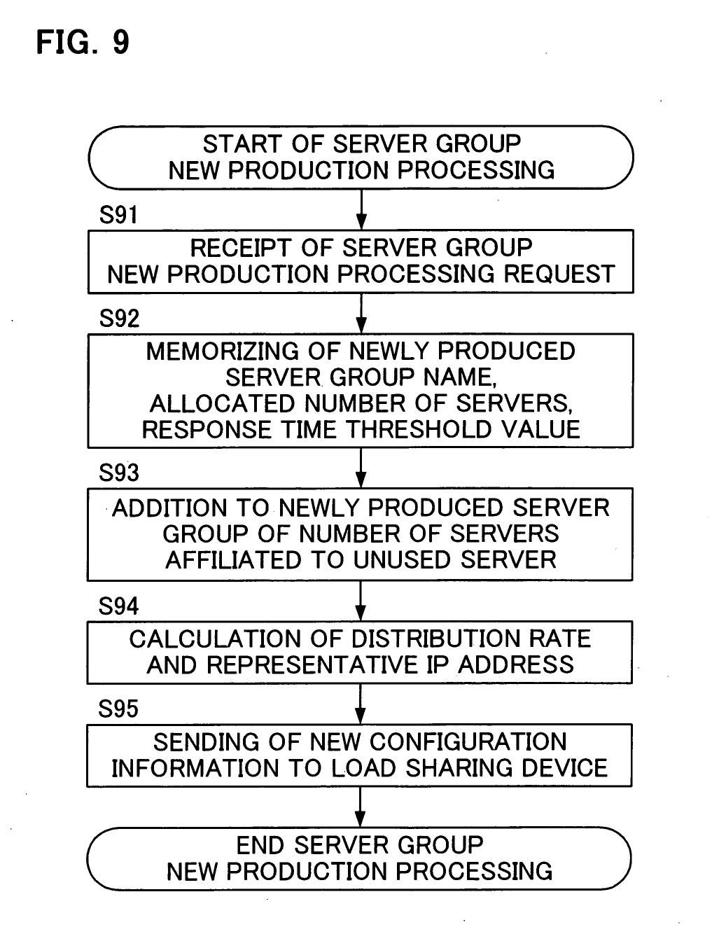

FIG. 9 is a flow chart for explaining new server group production processing. When establishing a new network service first the server group providing the network service will be defined. Then this process is executed.

First, the resource allocation controller 5 receives a new server group production request (S91). The new production of a server group 7 is normally based on the initiative of a operations manager and here is received as a command input by the operations manager by means of the input device 47 provided in the resource allocation controller 5. The name of the server group to be newly produced, along with the number of servers to be initially allocated and the response time threshold value, are received together as a command argument.

Next, the server group to be newly produced and the number of servers to be initially allocated and the response time threshold values are memorized (S92). In Step S92 the information received as the command argument is temporarily stored in the RAM 45 provided in the resource allocation controller 5.

Next, in such a way that the initial number of servers received in Step S91 is added to the newly produced server group, the data center configuration information is updated (S93). In Step S93, using the data center configuration information of FIG. 7, the initial number of servers received in Step S91 should be selected from the “unused” server entries of the affiliate server group name 74 and the column of the affiliate server group name 74 corresponding to the server selected should be altered to the name of the newly produced server group received in Step S91.

The representative IP address to be allocated to the newly produced server group and the distribution rate of each server affiliated to the server group is determined (S94). Although set by the load sharing device 4, the representative IP address and the distribution rate are determined by the resource allocation controller 5.

The determining of the representative IP address involves the selection of one arbitrary address from the set of unused IP addresses recorded in the hard disk of the resource allocation controller 5 (because it is exclusively for representative IP addresses) . Provided the sum of the distribution rates is 1 there are no particular restrictions to the method of determining the initial value of the distribution rate and, by way of example, the distribution rate for each server should be determined as the value obtained by dividing 1 by the initial number of servers received in Step S91.

When Step S94 concludes the new configuration information is sent to the load sharing device (S95) to complete the new server group production process. In Step S95 the newly produced server group name recorded in Step S92, the representative IP address, the response time threshold value, the server names of the initial number of servers selected in Step S93 and the distribution rate determined in Step S94 are sent to the load sharing device by the resource allocation controller.

Although the new production of a server group involves the execution of the process of FIG. 9, in order to determine whether the number of servers affiliated to the server group forms the optimum number of servers for providing the network service, the resource allocation controller 5 executes the following server allocation adjustment processing. Here, the CPU clock frequency is used as a number by which the processing potential of a server group is gauged, and the processing potential of a server group is improved by simple increasing the number of servers.

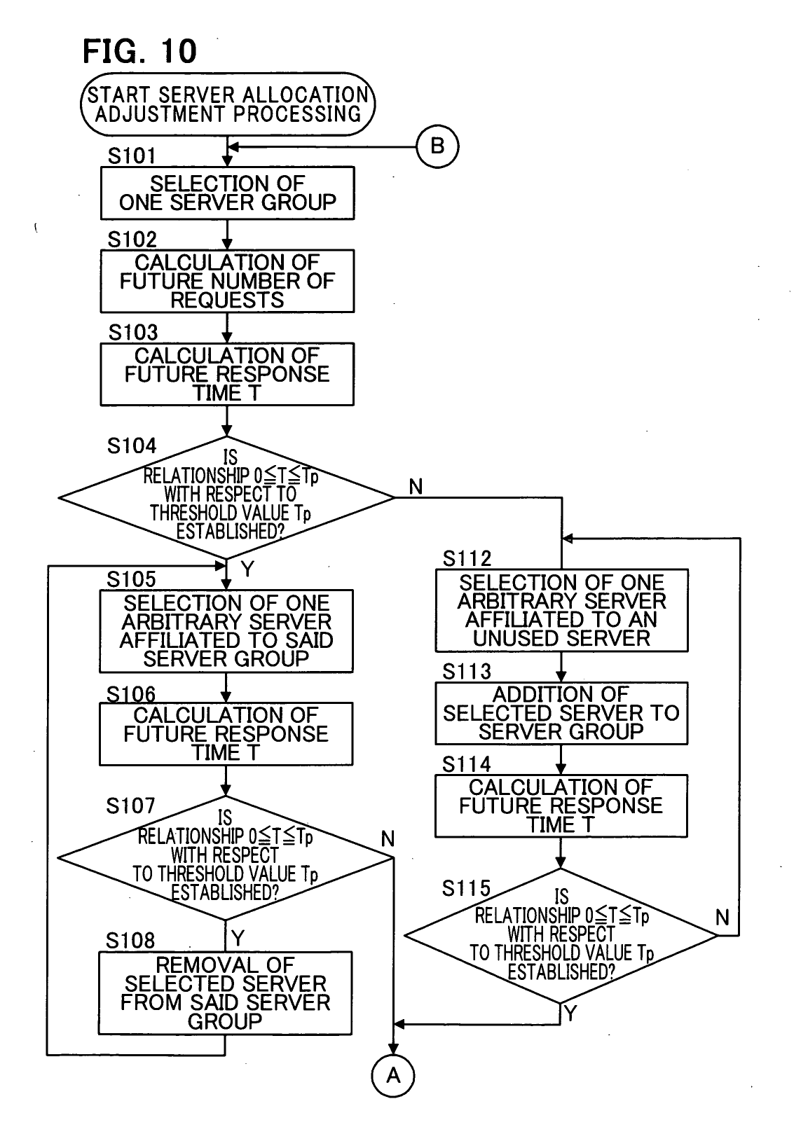

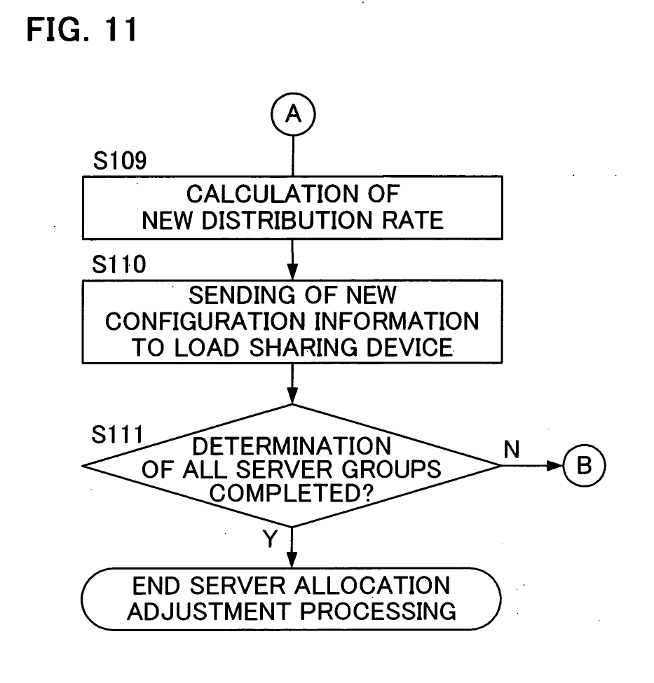

FIG. 10 and FIG. 11 are flow charts for explaining the server allocation adjustment processing. The resource allocation controller 5 executes the server allocation adjustment processing regularly to determine whether the number of servers allocated to the server group that provides the network services forms the optimum number of servers. The data of the table of FIG. 8 is input in advance of this processing.

First, one of the server groups providing the network service is selected (S101). The resource allocation controller 5, with reference to the affiliate server group name 74 of the data center configuration information of FIG. 7, selects one server group name other than an “unused” group name.

The number of arriving requests for a subsequent 60-second interval for the server group selected in Step S101 is predicted (S102). In Step S102, first, the resource allocation controller 5 requests from the load sharing device 4 the number of arriving requests for the most recent 300-second interval for the server group selected in Step S101, and the load sharing device 4, with reference to the statistical information of FIG. 6, sends the number of arriving requests 62 for the most recent 300-second interval for the corresponding server group to the request allocation controller 5. The number of arriving requests for a subsequent 60-second interval from the present time is predicted using the method of least squares based on the number of arriving requests acquired for the 300-second interval.

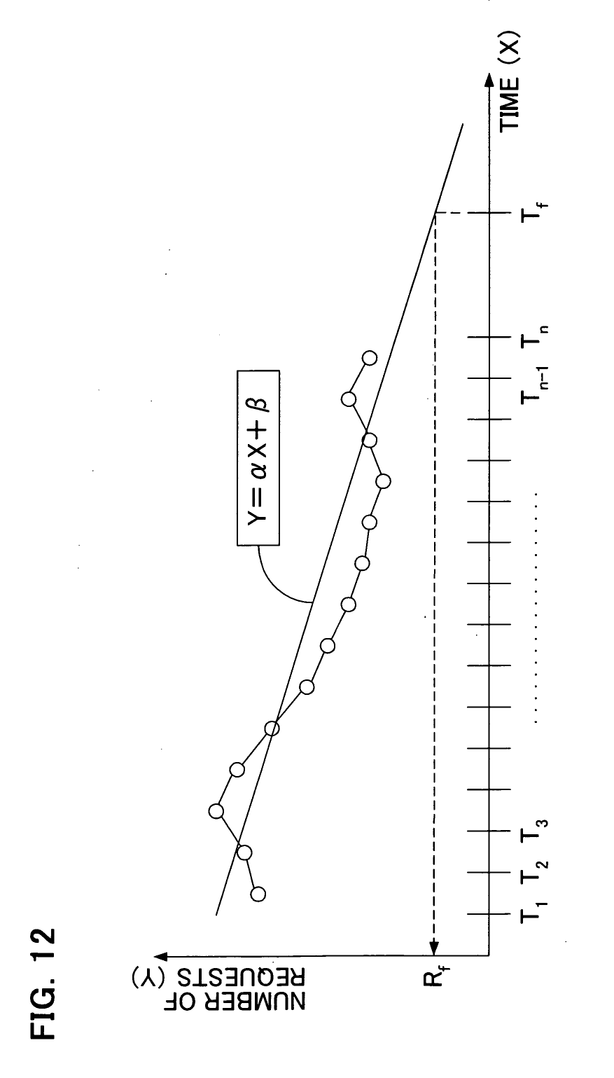

FIG. 12 is a diagram for explaining the method of prediction utilizing the method of least squares. In FIG. 12, in which time (seconds) is expressed on the X-axis and the number of arriving requests (number) is shown on the Y-axis, the data for a 300-second interval is plotted in a coordinate plane of one-second intervals. The straight line forming the minimum distance in the Y-axis direction from the points plotted on the coordinate plane is found using the method of least squares.

That is to say, α, β are found when the straight line is expressed as Y=α*X+β. The substitution of X=60 in this linear equation affords the calculation of a predicted value of the number of arriving requests for a subsequent 60-second interval. Where the calculated predicted value is less than 0 the predicted value for the subsequent 60-second interval is 0. It should be noted that in FIG. 12 the number of arrivals in each time interval is plotted as the number of arrivals at the midpoint of the time interval.

It should be noted that, although the number of arriving requests for a subsequent 60-second interval is predicted in Step S102, the time interval is not restricted thereto and can be determined in accordance with the aims of the operations manager. In addition, although data of the most recent 300-second interval is used to predict the number of arriving requests for a subsequent 60-second interval, the time interval is in no way restricted thereto. The criterion employed in this embodiment is data across an interval five times longer than the difference between the existing time and the future time interval for which the prediction is to be made.

The description is continued with reference again to FIG. 10. Next, based on the number of arriving requests predicted in Step S102, the average response time T for a subsequent 60-second interval for each server affiliated to the server group selected in Step S101 is calculated (S103).

The response time T is calculated using the following equation (A):

$$T = \frac{1}{μ {\sum }_{k = 1}^{n} {f}_{k} - R} \qquad ( A )$$

Here, μ is the average number of request processes per second at the standard clock frequency of the Web server software used by the servers affiliated to the server group selected in Step S101 and is a value found with reference to FIG. 8. R refers to the number of arriving requests to the server group selected in Step S101 for a subsequent 60-second interval and is equivalent to the value predicted in Step S102. fᵢ is the relative clock multiplying ratio of the i-th server of an n number of servers affiliated to the server group selected in Step S101 and is a value obtained from the CPU clock speed 73 of the data center configuration information of FIG. 7.

The method of calculation of equation (A) is as follows. Taking the server group as a whole selected in Step S101 as a single window for queue logic, the number of request processes per second at the window is

$$μ {\sum }_{k = 1}^{n} {f}_{k} ,$$

and the frequency of the arriving requests to the window equals the number of arriving requests R to the server group as a whole.

Assuming the arriving requests to the queue follow the Poisson model, the wait time of the arriving requests in the queue is:

$$\frac{ρ}{μ {\sum }_{k = 1}^{n} {f}_{k} - R}$$

Here, ρ refers to the window operation rate of the queue logic and shows the probability at any arbitrary point that the window is busy.

In a Poisson model, no queue overflow occurs when ρ<1, in other words, no matter how much time elapses the length of the queue is guaranteed to be maintained at a fixed length or below. In addition, the wait time shows the average response time T of the servers affiliated to the server group selected in Step S101. Thereupon, because ρ<1 even when the worst value of the response time of the abovementioned server is hypothesized, the relationship:

$$T = \frac{1}{μ {\sum }_{k = 1}^{n} {f}_{k} - R}$$

can be established. This is equation (A).

It should be noted that the response time of the i-th server affiliated to the server group selected in Step S101 can be calculated as follows. Taking the i-th server of the abovementioned server group as the window for queue logic and the number of request processes at the window per second as fᵢ*μ, the frequency of arriving requests to the window is equivalent to rᵢ*R which is obtained by multiplying the number of arriving requests R to the server groups as a whole by the distribution rate rᵢ of the i-th server.

Accordingly, based on a method of calculation identical to the calculation means of (A) described above, the response time Tᵢ of the i-th server affiliated to the abovementioned server group is established as:

$${T}_{i} = \frac{1}{{f}_{i} μ - {r}_{i} R} \qquad ( B )$$

A determination of whether the response time T calculated by Step S103 with respect to response time threshold value Tp set in advance satisfies the relationship 0≦T≦Tp is carried out (S104). Although the server level guaranteed by the agreement with the xSP is fulfilled so long as the response time T in Step S104 is within the range (0≦T≦Tp), if by some chance the number of allocated servers is in excess, this means that there is scope for reduction of the number of servers.

Thereupon, if the response time T in Step S104 is within the prescribed range, one arbitrary server affiliated to the server group is selected (S105). A configuration in which the server selected in Step S105 has been removed from server group selected in Step S101 is hypothesized, and the response time T for the hypothesized new configuration is re-calculated (S106). Step S106 is calculated by employing equation (A) identically to Step S103.

A determination of whether the response time T calculated by Step S106 with respect to the response time threshold value Tp satisfies the relationship 0≦T≦Tp is carried out (S107). Because the number of servers in the hypothesized configuration has been reduced by one, the value of the denominator is reduced and, accordingly, based on the previous calculation (Step S103), the response time T is increased. Accordingly, provided this increased value satisfies the relationship 0≦T≦Tp no problems arise as a result of the reduction in the number of servers by one.

Thereupon, if the relationship 0≦T≦Tp is satisfied in Step S107, the number of servers is actually reduced with the server selected in Step S105 added to the unused servers (S108). The implication of Step S108 is that, as a result of the updating of the affiliated server group name 74 of the data center configuration information of FIG. 7 that corresponds to the server selected in Step S105 to an unused server group, a server is removed from the configuration of the server group selected in Step S101.

When Step S108 concludes, the process returns to Step S105 to determine whether there is further scope for reduction of the number of servers. Because it is apparent that, if the response time T does not satisfy the relationship 0≦T≦Tp in Step S107, the existing configuration is equivalent to the minimum required level, the process proceeds without alteration to the configuration to the next process (moves to FIG. 11) where the distribution rate is calculated (S109).

In Step S109 of FIG. 11, the response times of each server affiliated to a server group can be equalized by calculating the distribution rate of each server affiliated to the server group using the following method. If the response time of the servers affiliated to the same server group are not equal, even if the average response time of the servers obtained by averaging the response times for the server group as a whole is equivalent to the response time threshold value or less, the response time of some servers will sometimes exceed the response time threshold value. Accordingly, the distribution rate of the servers must be controlled in such a way that the response time of the servers affiliated to the same server group is equalized.

The distribution rate of the Step S109 of FIG. 11 is calculated using equation (C):

$${r}_{i} = \frac{1}{n} ( 1 - \frac{μ}{R} {\sum }_{k = 1}^{n} {f}_{k} ) + \frac{μ}{R} {f}_{i} \qquad ( C )$$

Here, rᵢ is the distribution rate of the i^{th} server, n is the number of servers affiliated to the server group, μ is the average number of request processes per second at the standard clock frequency of the Web server software used by the server affiliated to the server group selected by Step S101, and R is the number of arriving requests to the server group as a whole selected in Step S101 for a subsequent 60-second interval and is a value predicted by Step S102. fᵢ is the relative clock multiplying ratio of the i^{th} server of an n number of servers affiliated to the server group selected in Step S101 and is a value obtained from the CPU clock speed 73 of the data center configuration information of FIG. 7.

The method of calculation of equation (C) is as follows. Based on equation (B), the response time Tᵢ of the i^{th} server is:

$${T}_{i} = \frac{1}{{f}_{i} μ - {r}_{i} R}$$

Here, in the hypothesizing of an equal response time of all n number of servers, because the relationship
T₁=T₂ . . . =Tₙ
is established, the relationship
f₁μ−r₁R=f₂μ−r₂R= . . . =fₙμ−rₙR,
that is to say

$${r}_{i + 1} = {r}_{i} + \frac{μ}{R} ( {f}_{i + 1} - {f}_{i} ) \qquad ( D )$$

is established.

Because, in modifying equation (D) and expressing rᵢ as r₁,

$$\begin{matrix}{r}_{1} = {r}_{i} \\ {r}_{2} = {r}_{1} + \frac{μ}{R} ( {f}_{2} - {f}_{1} ) \\ {r}_{3} = {r}_{2} + \frac{μ}{R} ( {f}_{3} - {f}_{2} ) \\ = {r}_{1} + \frac{μ}{R} ( {f}_{2} - {f}_{1} ) + \frac{μ}{R} ( {f}_{3} - {f}_{2} ) \\ = {r}_{1} + \frac{μ}{R} ( {f}_{3} - {f}_{1} )\end{matrix}$$

eventually the relationship:

$${r}_{i} = {r}_{1} + \frac{μ}{R} ( {f}_{i} - {f}_{1} ) \qquad ( E )$$

is established. Because, in taking the sum from 1 to n of the subscripts of both sides of equation (E) as:

$${\sum }_{k = 1}^{n} {r}_{k} = {nr}_{1} + \frac{μ}{R} {\sum }_{k = 1}^{n} ( {f}_{k} - {f}_{1} )$$

and the total distribution rate is one

$$( {\sum }_{k = 1}^{n} {r}_{k} = 1 ) ,$$

r₁ is found as follows:

$${r}_{1} = \frac{1}{n} ( 1 - \frac{μ}{R} {\sum }_{k = 1}^{n} ( {f}_{k} - {f}_{1} ) ) \qquad ( F )$$

If equation (F) is substituted with equation (E),

$${r}_{i} = \frac{1}{n} ( 1 - \frac{μ}{R} {\sum }_{k = 1}^{n} {f}_{k} ) + \frac{μ}{R} {f}_{i}$$

equation (C) is calculated.

When Step S109 concludes, the resource allocation controller 5 sends the new configuration information to the load sharing device 4, and the load sharing device 4 updates the server group configuration information with the received configuration information (S110). In Step S110, first the resource allocation controller 5 sends to the load sharing device 4 the server group name selected in Step S101, the server name 71 affiliated with the server group obtained with reference to the center data configuration information of FIG. 7, the IP address 72, and the distribution rate calculated in Step S109.

The updating of the load sharing device 4 should be performed at portions corresponding to the respective received information of the server affiliate information corresponding to the received server group name. A determination is carried out on all server groups to determine whether the allocation of the servers affiliated to the server group is appropriate and whether the processing beyond Step S102 has been completed (S111) and, where undetermined server groups still remain, the process returns to Step S101 and is continued. The process is completed when the determination of all server groups has been completed in Step S111.

If the response time T is not within the range 0≦T≦Tp in Step S104 of FIG. 10, one arbitrary server affiliated to an unused server is selected (S112). The server selected in Step S112 is added to the server group (S113).

If the reason the response time in Step S104 is not within the prescribed range is because the number of arrival requests exceeds the processing potential of the server groups, in other words, the denominator of equation (A) is negative, or is because, even though the number of arrival requests is within the range of the processing potential of the server groups, the load is such that the response time is less than the requested response time, in both cases the number of servers must be increased and the processing potential must be raised. Thereupon, an arbitrary unused server is selected in Step S112 and, in Step S113, the selected server is added to the server group selected in Step S101.

In the processing of Step S113, using the data center configuration information of FIG. 7, the resource allocation controller 5 should update the server group name 74 that corresponds to the server selected in Step S112 to the server group name selected from the “unused” servers in Step S101. The future response time T of the new configuration is recalculated (S114) using equation (A).

A determination of the response time T calculated by Step S114 is again carried out to determine if the response time is within the prescribed range (0≦T≦Tp) (S115). If it is still not within the prescribed range in Step S115 following the addition of one server and the service level guaranteed by the agreement with the xSP has still not been satisfied, the process returns to Step S112 for the further addition of a server. If the response time is within the prescribed range in Step S115 the process proceeds to Step S109 and the distribution rate is calculated.

It should be noted that, provided the new server group production request is made during the execution of this process, the resource allocation controller 5 can be set in such a way as to execute the new server group production process of FIG. 9 as interruption processing.

Based on the embodiment of the present invention described above, a method can be provided by the present invention in which the allocation of servers to network services in a data center is automatically implemented in real time and without need for operators of the load sharing device. In addition, fluctuations in the quantity of requests arriving at the network services can be monitored, the value of the quantity of requests for a subsequent fixed time interval can be predicted and, in accordance with the magnitude of the predicted value for the quantity of requests, the quantity of servers allocated for the network services can be controlled.

Accordingly, the load on the operations managers can be reduced and the operation can be implemented using fewer operations managers. In addition, the operations can be carried out by operations managers of little experience. Here, where traffic of the quantity indicated by the predicted value for the quantity of requests arrives at the network services, the number of servers allocated to the network services can be set in such a way that the average response time to the user terminals is equivalent to a response time threshold value or less set in advance by the operations manager.

Accordingly, the service level that should be maintained in accordance with the agreement and so on with clients of the data center such as an xSP can be maintained to a fixed standard or better. In addition, because a determination is carried out to determine whether the response time based on the predicted value is within the prescribed range each time the number of servers is increased or decreased by one, the server group can be configured from a number of servers equivalent to the necessary minimum value for the operation of the networks service and, accordingly, the data center is able to operate its server resources at maximum efficiency.

Although, in the embodiment of the present invention as described above, a web server is used as the server application and the requests from the user terminal are http requests, other application programs can be used by all servers, and the application of the present invention is possible in any case where the user terminal sends a request to the application program and the server sends a reply to this user terminal. It should be noted that, although the CPU clock frequency is used as a number by which the processing potential of the server group is gauged in the embodiment of the present invention, and the number of servers is simply increased or decreased in order to adjust the processing potential of a server group, the application of the present invention is also possible in cases in which, by the individual numerization of, for example, the CPU, memory and hard disk, individual calculating resources are increased or decreased.

In addition, although the standard clock frequency is taken as 1 GHz in the embodiment of the present invention the frequency is not restricted thereto. In such cases, provided the average number of processes of each application in a server which has a clock frequency established as the standard clock frequency is accumulated in advance and input into the response allocation controller in advance as shown in FIG. 8, the application of the present invention is possible.

The scope of protection of the present invention is not restricted to the embodiment described above and extends to the inventions described in the scope of the patent claims and their equivalent.

### INDUSTRIAL APPLICABILITY

Based on the embodiment of the present invention described above, a method can be provided by the present invention in which the allocation of servers to network services in a data center is automatically implemented in real time and without need for operators of the load sharing device. In addition, fluctuations in the quantity of requests arriving at the network services can be monitored, the value of the quantity of requests for a subsequent fixed time interval can be predicted and, in accordance with the magnitude of the predicted value of the quantity of requests, the quantity of servers allocated to the network services can be controlled.

1. A method for adjusting the number of servers belonging to a server group in a network system which includes a plurality of user terminals connected to a network and server groups each containing a plurality of servers connected to said network to process requests from said plurality of user terminals, the method comprising:
storing the number of requests from said plurality of user terminals for prescribed time intervals;
finding a function to describe a characteristic between time and the number of requests on the basis of a previous stored number of requests;
predicting the number of future requests by substituting a future time for said function;
obtaining a first average response time per server of said plurality of servers by substituting said predicted number of requests in a relational expression of the number of requests and an average response time per server of the plurality of servers where it is hypothesized that the number of requests from said plurality of user terminals follows a prescribed probability distribution;
determining whether said first average response time is a positive value and within a range no more than a threshold value set in advance, and
increasing or decreasing the number of servers contained in said server group in accordance with the result of said determination.

2. The method for adjusting the number of servers belonging to a server group according to claim 1, further comprising:
selecting one of the servers of said server group if the result for said first average response time in said determination is within said range;
hypothesizing that said selected server has been removed from a server group;
finding a second average response time per server of the plurality of servers of said hypothesized server group;
performing a new determination whether or not said second average response time is within said range; and
removing said selected server from the configuration of said server group if the result for said second average response time of said new determination is within said range.

3. The method for adjusting the number of servers belonging to a server group according to claim 2,
wherein said selecting, said hypothesizing, said finding a second average response time, said performing a new determination and said removing are repeated and
wherein the server belonging to said server group is removed one-by-one until the result for said second average response time in said new determination is outside said range.

4. The method for adjusting the number of servers belonging to a server group according to claim 1,
wherein said network system includes an unused server group having a plurality of unused servers connected to said network,
the method further comprising:
selecting one of the servers of said unused server group if the result for said first average response time in said determination is not within said range; and
adding said selected server to said server group.

5. The method for adjusting the number of server groups according to claim 4, further comprising:
finding a third average response time per server of the plurality of servers included in a new server group following the addition of said selected server;
performing a new determination whether said third average response time is within said range; and
selecting one of the servers of said unused server group if the result for said third average response time of said new determination is not within said range,
wherein said finding a third average response time, said performing a new determination and said selecting are repeated and
wherein the server belonging to said unused server groups is added one-by-one to said server group until the result for said third average response time of said new determination is within said range.

6. A program for a resource allocation controller connected to a network in a network system which includes a plurality of user terminals connected to said network, server groups each containing a plurality of servers connected to said network to process requests from said user terminals and a load sharing device connected to said network involving a storage storing the number of requests from said user terminal for prescribed time intervals, a distribution rate of said number of requests and a configuration information of said server groups,
the program causing the resource allocation controller to execute the method comprising:
finding a function to describe a characteristic between time and the number of requests on the basis of a previous stored number of requests stored in the load sharing device;
predicting the number of future requests by substituting a future time for said function;
obtaining a first average response time per server of said plurality of servers by substituting said predicted number of requests in a relational expression of the number of requests and an average response time per server of the plurality of servers where it is hypothesized that the number of requests from said plurality of user terminals follows a prescribed probability distribution;
determining whether said first average response time is a positive value and within a range no more than a threshold value set in advance, and
increasing or decreasing the number of servers contained in said server group in accordance with the result of said determination.

7. The program according to claim 6, further causing the resource allocation controller to execute the method comprising:
selecting one of the servers of said server group if the result for said first average response time in said determination is within said range;
hypothesizing that said selected server has been removed from a server group;
finding a second average response time per server of the plurality of servers of said hypothesized server group;
performing a new determination whether or not said second average response time is within said range; and
removing said selected server from the configuration of said server group if the result for said second average response time of said new determination is within said range.

8. The program according to claim 7,
wherein said selecting, said hypothesizing, said finding a second average response time, said performing a new determination and said removing are repeated and
wherein the server belonging to said server group is removed one-by-one until the result for said second average response time in said new determination is outside said range.

9. The program according to claim 6,
wherein said network system includes an unused server group having a plurality of unused servers connected to said network,
further causing the resource allocation controller to execute the method comprising:
selecting one of the servers of said unused server group if the result for said first average response time in said determination is not within said range; and
adding said selected server to said server group.

10. The program according to claim 9, further causing the resource allocation controller to execute the method comprising:
finding a third average response time per server of the plurality of servers included in a new server group following the addition of said selected server;
performing a new determination whether said third average response time is within said range; and
selecting one of the servers of said unused server group if the result for said third average response time of said new determination is not within said range,
wherein said finding a third average response time, said performing a new determination and said selecting are repeated and
wherein the server belonging to said unused server groups is added one-by-one to said server group until the result for said third average response time of said new determination is within said range.
